(19) United States
(12) Patent Application Publication
(10) Pub. No.: US 2004/0107216 A1
(43) Pub. Date: Jun. 3, 2004

(54) VIRTUAL GRAVEYARD AND MEMORIAL SITE

(76) Inventors: Gvozded Dokic, Astoria, NY (US); Thomas A. Platt, Brooklyn, NY (US)

Correspondence Address: GREENBERG & LIEBERMAN, 314 PHILADELPHIA AVE., TAKOMA PARK, MD, 20912, US

(21) Appl. No.: 10/604,305

(22) Filed: Jul. 9, 2003

Related U.S. Application Data
(60) Provisional application No. 60/319,383, filed on Jul. 9, 2002.

(51) Int. Cl. G06F 17/00

(52) U.S. Cl. 707/104.1

(57) ABSTRACT

A virtual memorial site available for users to mourn their recently passed loved one, or for a person to enter information about themselves for others to view after they have passed on. The two necessary components of the virtual memorial site are the virtual space for friends and family to post information on the funeral services and visitation, and a space for people to enter autobiographical information about themselves, or letters and information for loved ones after they pass on. Additionally there are cyber cemeteries devoted to particular religions or interests.

### CROSS REFERENCE TO RELATED APPLICATIONS

Priority is hereby claimed to provisional application 60/319,383, in the name of Gvozded Dokic, and Thomas Platt, entitled Virtual Graveyard and Memorial Site, on Jul. 9, 2002.

### BACKGROUND OF INVENTION

The present invention is a virtual space wherein a user may enter biographical information on a deceased person, or a living person can enter information about himself for viewing while alive and/or for others to view once deceased.

There are several venues in which a person can memorialize himself or create an autobiographical record for posterity. Many people choose to write journals or memoirs to leave for loved ones when they have passed. Additionally, people can leave writings or letters to others in their will, or to be delivered upon their death. However, each of these options allows the person receiving the memoir or letter to keep that information private, or to share the information with others who may not have been intended to see the information.

There are also web sites available for famous people, such as actors or politicians, which memorialize a lifetime of work. Additionally, family members can set up websites to memorialize their deceased loved ones. However, there are no sites available for living persons to enter autobiographical information about themselves, for posterity. Further, none of the websites actually depart from the physical world; that is, no websites exist where a person can make a living memorial or post mortem memorial appear to exist in any mode such as on the tip of a flower, or on the belly of an ant. Clearly, there are definite limit to current web sites.

The website http://www.geocities.com/area51/9679/contents.html shows a story scheme that users may add to regarding Armageddon and time travel. This website is unlike the present invention because it is a fiction story that users may add to or participate in email based futuristic games. It does not provide a means for a user to create a memorial for him or herself, or for a loved one.

The website http://www.dgbn.com/coldmarble/# has links to particular graveyard. This site is unlike the present invention because it shows set pictures of statues and other adornment of particular graveyards. It does not provide a means for the user to create a memorial of himself or herself, or a loved one, and it does not provide a real time link to a particular gravesite, or a means for users to record particular images to be displayed on a tombstone.

The website http://www.nhne.com/newsbriefs/nhnenb50.html shows a news article displaying ajapanese Buddhist Monastery creating a virtual graveyard. This site is unlike the present invention because it does not provide a real time video feed at a tombstone, and it does not provide a way to display images at a tombstone of the loved one.

The website http://www.dogchurch.org/indexfrm.html shows the Virtual Church of the Blind Chihuahua's virtual graveyard. The website is unlike the present invention because it does not provide a means for users to add information or files about a deceased loved one, or a means to have real time video feed to a particular gravesite. Additionally the site implies that the site is considered a humorous site and does not provide a serious consideration of a particular or many deceased people.

The website http://www.cavyland.org.uk/memorial.html shows a virtual pet memorial site. This website is unlike the present invention because it provides only a space for pet memorials instead of a space for human memorials, and it does not provide live video feed to a particular tombstone.

The website http://www.rootsweb.com/˜padelawa/delgrav.htm shows a virtual graveyard for Delaware County. This website is unlike the present invention because it is a site for gathering particular burial data for graveyards in one county, it does not provide a memorial space for a particular person and it does not provide a real time video feed to a particular gravesite.

Thus, there is a need for a virtual space, accessible via the Internet, which allows creation of personal space in any type or form imaginable. There is a need for a space, which can be a living memorial (a curriculum vitae of a virtual kind), or a memorial to someone who has died, or both (in which case the living memorial transforms into a memorial about a departed individual).

Heretofore, there has been no solution to the above needs.

### SUMMARY OF INVENTION

The present invention is a virtual memorial site available for users to mourn their recently passed loved one, or for a person to enter information about themselves for others to view during the person's lifetime and then after they have passed on. The two preferred components of the virtual memorial site are the virtual space for friends and family to post information on the funeral services and visitation, and a space for people to enter autobiographical information about himself or herself, or letters and information for loved ones after they pass on. However, the ability for the present invention to allow the memorial to appear online in any shape and/or form is an appealing feature.

The first component allows family members to set up a web site where they can set up memorial service information, and services or food items that the family may need. There is also a section for the family to set up a virtual gravesite for their loved one. They can choose a conventional headstone, or create a headstone in a theme particular to their loved ones. Additionally there is a function to allow the family to post an event interactive web page. The event interactive web page can include live web casting of the ceremony at the funeral home or church as well as the service from the gravesite. Also there is a live time chat function, called a condolence chat which can put family members in touch over large distances and can also put grievers in touch with pastors, rabbis, or other grief counselors in separate embodiments of the present invention. Also the users may add an additional money based service to connect them to local florists, videographers and the like. This system can also be used for general memorial reunions, such as Memorial Day services. There is also a function to allow the family to post videotape or live web casting of the funeral service to be accessed at any time for any persons who may not be able to make the trip to the funeral service.

The second component allows persons to enter autobiographical information about themselves, or letters for loved ones when they pass on. Additionally the users may enter information to be used by the family to construct the virtual gravesite after their passing.

### DETAILED DESCRIPTION

The present invention is avirtual gravesite and memorial system. The virtual gravesite has two major components: “To Eternity,”http://www.toeternity.com, a place to memorialize deceased friends and family, and “I'm Eternal,”a place for user to enter information about themselves, http://www.bigjacket.com, for others to view after they have passed on, or as living memorial.

The toEterinity section of the website provides a permanent space on the World Wide Web to be a virtual final resting place for any person. When a loved one passes on a person close to them, such as a relative or friend, could establish a virtual gravesite, post information about what is needed by the family, or even create a download of the video, or live web casting of the funeral and visitation services for those who were unable to physically be there. This can include live and archived video of the services, condolence chats with grief professionals, or with other family members. Additionaly any charity information requested by the deceased can be added, including the possibility of a money subscription site for users to contribute to flower delivery, video processing of the services, etc. The deceased can also by pre-arrangement set up the virtual gravesite before passing to include what they would like their final virtual resting place to be. Also the users may have a link to the printed obituaries and information on ordering the obituaries from the local newspapers.

The family can choose a conventional looking gravesite such as a headstone in a field, or an unconventional gravesite such as virtually burying their loved one next to a famous musician or politician; i.e. John Lennon, or John F. Kennedy. They could also choose such an unconventional option as a crypt orbiting a planet. Additionally there are sites for particular religious groups, such as Christian, Jewish, Muslim or other applicable religions. There are also group cemeteries for particular interests such as Harley Davidson riders, Dead Heads, or jazz or classical music aficionados. Additionally the site encompasses three-dimensional tours through a virtual cemetery. The subscribers may take virtual tours through the cemetery and the three dimensional effects allow the user to see the cemetery as if they were walking through it in person. The views would be much like the effect given by first person shooter video games, and would create the illusion of space and actual virtual existence of the resting place of their loved ones.

Through toEternity accounts the family and friends of the deceased are able to exchange information and calendar events important to the deceased such as birth and death dates of the deceased. Also the families may use the calendaring to notify users of upcoming events such as gatherings. The users can also create event virtual pages for the funeral and visitation services, so family members and friends who cannot physically be there may still participate through the web site.

The system may also be used for large memorials. For example the city of New York could host a page for the victims of the Twin Towers tragedies of 9-11 and their families. Included in the site can be links to charitable organizations related to the tragedy. Another example is that the US government could set up online memorials for veterans lost in particular wars, for example WW2. The war veteran sites can be linked to VFW and other lodge activities and direct users as to how to participate in charities and actions related to these charities.

The site can host a plethora of sound files, video, text or pictures and can be limited in access to the friends and family or available to the general public. Additionally as friends and family mourn they can add memories or thoughts about their loved one in any of the above formats. There are also additional genealogical services such as three-dimensional family trees. Also there are options where the family members can add URL links to sites that their loved one may have been interested in, such as religious sites, or the site of their favorite celebrity or author. These services would be on a fee basis for the user depending on use of the different multimedia options.

Bigjacket.com creates a stable place on the World Wide Web for users to post personal stories, autobiographies, biographies, or tributes to themselves. There is also the capability to include a personal diary or memoir using sound files, video, text or pictures.

Additionally as the technology becomes more readily available users will be able to include a virtual person copy of themselves that others could interact with. The user will determine levels of access and security and they can restrict access by password or encryption methods.

I'm Eternal will allow users to have a personal showcase including emails,memoir, songs, voice recordings, or pictures that has meaning to them. The users canadd new displays for the others to view, and the persons they have chosen to have accessto the site can be notified automatically by use of emails, pager, or PDA text messages.

Each of these services would be fee based depending on space and multimedia used.

Additionally, the users can sign a guest book so there is a record of the guests who havecome to the site. The system also has a listserv option, which can notify family membersabout memorial services or any other events or programs requested by the users.

Also the site will have links to local funeral homes, florists, and like services to help the family find services in their area.

The present invention also has a concept of a “cubby hole.”Much like the little open cubicles used by children in elementary school, the cubbyhole is a space where members can send, retrieve, and store files for each other.The cubbyhole differs from email in that it is a depository for files, whether they include a document, a sound, a picture, etc.Users can leave anonymous or “signed” files in a user's cubbyhole.This will be a service available for member-to-member use only. Thus, the cubbyholes provide a method by which information may be passed from one user's site to another user's site. Roughly, this mimics the transfer of information from one person to another, during a lifetime and/or upon death. The transfer of information could even be timed to occur upon the death of an individual, or when the user indicates that death is near.

The present invention is not limited to the sole embodiments described above.

1. A system and method of online memorial creation, comprising:
a first stable station on the Internet for a user to create a living memorial of him or herself;
a second stable station, linked to said first stable station, on the Internet for a user to create a memorial of a deceased person or persons;
a third stable station, linked to said first and second stable stations, on the Internet for live web casting of a funeral or memorial services;
a chat function, linked to said first, second and third stable stations, for users to talk to each other and communicate over a variety of subjects;
a media file storage facility, linked to said first, second and third stable stations, to allow users to store video, audio or data files; and
Web-crafting tools incorporated in said first, second, and third stable stations, allowing a user or users to create sites about themselves or others.

2. A system and method of online memorial creation as in claim 1, wherein said first stable station has a means for a user to set up an account and enter personal information in data, video or audio format, for other authorized users to access during the user's life or after the users death.

3. A system and method of online memorial creation, as in claim 1, wherein said second stable station, allows a user to set up an account to enter information on a deceased person, including any biographical information, in data, video, or audio files, for other authorized users to view.

4. A system and method of online memorial creation, as in claim 2, further comprising a calendaring system to allow authorized users to enter important dates regarding the deceased person, such as visitation or funeral services as well as other important dates, such as birth date, death date, and anniversaries.

5. A system and method of online memorial creation, as in claim 2, further comprising a live web casting of visitation, memorial, funeral or graveside services for authorized users to view in real time, or at a later date, if they cannot physically be at these services.

6. A system and method of online memorial creation, as in claim 2, further comprising links to local florists and charities which can be used by authorized users to commemorate the deceased.

7. A system and method of online memorial creation, as in claim 2, further comprising a bulletin board system for authorized users to leave messages for family's members of the deceased.

8. A system and method of online memorial creation as in claim 1, further comprising a live video and audio feed to a gravesite of the deceased, or to a favorite place of the deceased.

9. A system and method of online memorial creation, as in claim 1, further comprising a means for a spanning memorial to be set up for a group of persons as victims of a tragedy.
